(19) United States
(12) Patent Application Publication
(10) Pub. No.: US 2005/0268264 A1
(43) Pub. Date: Dec. 1, 2005

(54) Apparatus and method for calculating crosstalk

(75) Inventor: Koichi Nagai, Kanagawa (JP)

Correspondence Address: FOLEY AND LARDNER;SUITE 500, 3000 K STREET NW, WASHINGTON, DC, 20007, US

(73) Assignee: NEC Electronics Corporation

(21) Appl. No.: 11/134,387

(22) Filed: May 23, 2005

(30) Foreign Application Priority Data
May 25, 2004 (JP) 2004/155225

(51) Int. Cl. G06F 9/45

(52) U.S. Cl. 716/6; 716/5

(57) ABSTRACT

In a crosstalk calculating method, a basic noise amplitude signal applied to a victim net is determined in a basic noise generation period specified based on a voltage signal transferred on an aggressor net in a semiconductor circuit. First and second signal portions applied to the victim net in first and second transition periods to be added are added to a front and back of the basic noise generation period to a front and back of the basic noise amplitude signal based on the voltage signal, respectively, to produce a noise amplitude signal.

### BACKGROUND OF THE INVENTION

1. Field of the Invention

The present invention relates to a design of a semiconductor integrated circuit, especially relates to a technique to analyze crosstalk generated in a semiconductor integrated circuit to be designed.

2. Description of the Related Art

Measures to turbulence of a digital signal waveform have been become important in accompaniment with the miniaturization and complicating of wirings in a semiconductor integrated circuit. Various factors cause the turbulence of the digital signal waveform. One factor is a signal response error due to a coupling capacitance. It is well known that the signal response error is caused through mutual interferences of voltage signals (Hereafter, to be referred to as crosstalk) on signal lines arranged adjacently in the semiconductor integrated circuit. The turbulence of the signal waveform through the above-mentioned crosstalk will be described below by using a simple circuit model.

FIG. 1 shows a configuration of a conventional semiconductor circuit. As shown in FIG. 1, a conventional semiconductor circuit 100 is configured of an aggressor net 101, an aggressor net 102, and a victim net 103. It is supposed that a signal with a waveform 101a shown in FIG. 1 is transferred on the aggressor net 101, a signal with a waveform 102a shown in FIG. 1 is transferred on the aggressor net 102, and a signal with a waveform 103a shown in FIG. 1 is transferred on the victim net 103. Here, the victim net 103 receives influence of crosstalk, i.e., noises through the voltage change of the signals 101a and 102a on signal lines of the aggressor nets 101 and 102.

FIGS. 2A to 2D show specific examples of the turbulence of the signal waveform due to the crosstalk. A waveform 201 shown in FIG. 2A shows a time-dependent change of a voltage signal transferred on the aggressor net 101. A waveform 202 shown by a solid line in FIG. 2B shows a time-dependent change of the voltage signal on the victim net 103 that is influenced by the voltage signal on the aggressor net 101. As shown in FIGS. 2A and 2B, when the signal on the aggressor net 101 changes from “High level” into “Low level”, the signal on the victim net 103 is influenced by the voltage change on the aggressor net 101. Referring to the waveform 202 shown in FIG. 2B, the delay in the signal on the victim net 103 increases due to the influence of the voltage change on the aggressor net 101, and the signal on the victim net 103 reaches the threshold voltage Vt at a time t2.

A waveform 203 in FIG. 2C shows a time-dependent change of the voltage signal transferred to the aggressor net 102. A waveform 204 shown in FIG. 2D shows a time-dependent change of the voltage signal on the victim net 103 in this case. As shown in FIGS. 2C and 2D, when the signal voltage of the aggressor net 102 changes from “Low level” into “High level”, the signal on the victim net 103 is influenced by the signal voltage change on the aggressor net 102. Referring to the waveform 204 shown in FIG. 2D, the delay in the signal on the victim net 103 decreases due to the influence of the signal voltage change on the aggressor net 102, and the signal on the victim net 103 reaches the threshold voltage Vt at a time t3, though the signal normally reaches the threshold at a time t4.

A conventional technique is known, in which the influence of crosstalk is calculated in the design stage of a semiconductor integrated circuit in order to prevent a signal transferred on one net from influencing a signal transferred on another net due to the crosstalk. Such a conventional technique is described in “TACO: Timing Analysis With Coupling” by Ravishankar Aru Nachalam, Karthik Rajagopal and Lawrence T. Pileggi (Design Automation Conference 2000 Proceeding, pp. 266-269).

FIGS. 3A to 3C show noise amplitude signals that are calculated by the conventional crosstalk calculating method based on a signal transferred on the aggressor net. FIG. 3A shows a time change of an actual voltage signal transferred on the aggressor net. As shown in FIG. 3A, a signal 301 has the minimum delay when the signal 301 is transferred on an aggressor net. A signal 302 has the maximum delay when the signal 302 is transferred on the aggressor net. According to the conventional crosstalk calculating method, when the signal 301 shown in FIG. 3A acts as a noise source to another signal line, an operation timing period during which the noise may be generated is defined as a period from a time Tf when the signal 301 reaches the threshold voltage Vt to a time Tt when the signal 302 reaches the threshold voltage Vt. In the conventional crosstalk calculating method, a noise calculation is carried out under the assumption that the noise is generated during the above-mentioned period from the time Tf to the time Tt.

FIG. 3B shows a noise amplitude signal 303 calculated by the conventional crosstalk calculating method. As shown in FIG. 3B, the noise amplitude signal 303 calculated by the conventional crosstalk calculating method is a rectangular pulse voltage signal. The noise amplitude signal 303 becomes maximum when the voltage signal 301 reaches the threshold voltage Vt, and becomes minimum when the voltage signal 302 reaches the threshold voltage Vt. That is, the noise amplitude signal becomes minimum when the period during which the noise can be generated passed away.

As described above, the noise amplitude signal is calculated by the conventional crosstalk calculating method. However, if a shift of the operation timing in time is generated on the aggressor net, the crosstalk is generated at the shifted time. As the result of the generation of the new crosstalk, a new noise amplitude signal might be suddenly calculated in the period during which the noise was not generated in the previous noise calculation. In the design of the semiconductor integrated circuit, it is necessary to modify the layout so as not to be influenced by a new noise signal each time the new noise signal is calculated.

Also, the noise signal is possibly generated even when the voltage signal on the aggressor net is equal to or less than the threshold Vt (for example, in the periods from the time T1 to the time Tf or from the time Tt to the time T4, and the like). A technique is well known, in which the operation timing period is slightly elongated to cope with the noise generated in the period when the voltage signal is equal to or less than the threshold Vt. FIG. 3C shows a noise amplitude signal 304 when the defined operation timing period is extended in the conventional crosstalk calculating method. As shown by the noise amplitude signal 304 in FIG. 3C, the noise amplitude signal 304 when the defined operation timing period is extended has a rectangular pulse waveform as well as the noise amplitude signal 303. The noise amplitude signal 304 is calculated under the assumption that the extended operation timing period is from a time T1 when the signal 301 is supplied to a time T4 when the signal 302 reaches the power supply voltage “High level”. The crosstalk analysis using the noise amplitude signal shown in FIG. 3C is effective to avoid a problem that a new noise must be suddenly calculated. Estimating the long-term operation timing period in the design of the semiconductor integrated circuit reduces the flexibility of choice of layout in the design of the semiconductor integrated circuit. Therefore, the long-term operation timing period increases in cost and labor in the design of the semiconductor integrated circuit. Especially, when one victim net is influenced from a plurality of aggressor nets, the design of the semiconductor circuit becomes very difficult if the long-term operation timing period is assumed. The crosstalk analysis in a case that one victim net is influenced from a plurality of aggressor nets will be described below.

FIG. 4 is a circuit diagram showing a specific example of a conventional semiconductor integrated circuit. As shown in FIG. 4, a circuit 400 is configured of a plurality of nets. A net 401 is a victim net. Nets 402 to 404 are aggressor nets to the net 401. FIG. 5 shows a process of analyzing the crosstalk to the net 401 by the conventional crosstalk calculating method. A signal 501 shown in FIG. 5 indicates a noise-amplitude signal on the net 402. Similarly, a signal 502 shows a noise amplitude signal on the net 403, and a signal 503 shows a noise amplitude signal on the net 404. Also, a signal 504 shows a composite noise amplitude signal generated by adding the noise amplitude signals from the respective aggressor nets (402-404). In the circuit 400 configured of a plurality of nets, the net 401 as the victim net receives the influence of the noise amplitude signals from the respective aggressor nets (402-404). Therefore, in the victim net 401, it is needed to consider that the noise amplitude signals from the plurality of the aggressor nets are added, as shown in the composite noise amplitude signal 504 (hereafter, to be referred to as a victim noise).

As mentioned above, when the victim net is influenced from the plurality of aggressor nets, the victim noise calculated by the conventional crosstalk calculating method directly receives influence of the shift of the operation timing period in the aggressor nets so that a new crosstalk is generated. Also, the victim noise is a resultant noise when the noise amplitude signals from the plurality of aggressor nets are added. Therefore, it is desirable that the operation timing period is a short term in the crosstalk analysis.

### SUMMARY OF THE INVENTION

In an aspect of the present invention, a crosstalk calculating method is achieved by determining a basic noise amplitude signal applied to a victim net in a basic noise generation period specified based on a voltage signal transferred on an aggressor net in a semiconductor circuit; and by adding first and second signal portions applied to the victim net in first and second transition periods to be added to a front and back of the basic noise generation period to a front and back of the basic noise amplitude signal based on the voltage signal, respectively, to produce a noise amplitude signal.

Here, the determination of a noise amplitude signal may be achieved by determining a start time of the basic noise generation period based on a threshold and the voltage signal with a minimum delay; and by determining an end time of the basic noise generation period based on the threshold and the voltage signal with a maximum delay.

Also, the addition of first and second signal portions may be achieved by adding the first signal portion in the first transition period to the front of the basic noise amplitude signal based on a rising waveform of the voltage signal with a minimum delay; and by adding the second signal portion in the second transition period to the back of the basic noise amplitude signal based on a falling waveform of the voltage signal with a maximum delay. In this case, the first signal portion is a gradually increasing signal, and the second signal portion is a gradually decreasing signal.

Also, the crosstalk calculating method may be achieved by further carrying out the determining a basic noise amplitude signal and the adding first and second signal portions for each of a plurality of the aggressor nets in the semiconductor circuit; by further grouping the plurality of aggressor nets into groups based on a clock signal to be used; and by further adding the noise amplitude signals for each group to produce a composite noise amplitude signal for the victim net.

Also, the crosstalk calculating method may be achieved by further adding an extension period signal in an extension period after the basic noise generation period before the second transition period to the back of the basic noise amplitude signal, to produce the noise amplitude signal in which the first and second signal portions and the extension period signal are added. The extension period signal in the extension period has a same amplitude as that of the basic noise amplitude signal. In this case, the crosstalk calculating method may be achieved by further carrying out the determining a basic noise amplitude signal, the adding first and second signal portions and adding an extension period signal for each of a plurality of the aggressor nets in the semiconductor circuit; by further grouping the plurality of aggressor nets into groups based on a clock signal to be used; and by further adding the noise amplitude signals for each group to produce a composite noise amplitude signal for the victim net.

Also, the crosstalk calculating method may be achieved by further separating the basic noise amplitude signal into first and second basic noise amplitude signal based on a clock period when the basic noise generation period is over two clock periods; and by shifting the second basic noise amplitude signal at a start of the clock period. The addition of first and second signal portions may be achieved by taking, when the first and second transition periods overlap, a larger one of the first and second signal portions for the overlapping period.

Also, the crosstalk calculating method may be achieved by further separating the basic noise amplitude signal into first and second basic noise amplitude signal based on a clock period when the basic noise generation period is over two clock periods; and by shifting the second basic noise amplitude signal at a start of the clock period. The addition of an extension period signal may be achieved by taking, when the extension period and a period for the first basic noise amplitude signal overlap, the extension period signal for the overlapping period.

In another aspect of the present invention, a crosstalk calculating apparatus includes a part database configured to store data of parts of a semiconductor circuit which comprises a plurality of circuit nets; a layout database configured to store data of a layout of the semiconductor circuit; a signal database configured to store signals on the plurality of circuit nets; and a processing unit configured to carry out a crosstalk calculating process. The processing unit specifies one of the plurality of circuit nets as a victim net and another of the plurality of circuit nets as an aggressor net; refers to the part database, the layout database and the signal database to determine a basic noise amplitude signal applied to a victim net in a basic noise generation period specified based on a voltage signal transferred on an aggressor net in a semiconductor circuit; and adds first and second signal portions applied to the victim net in first and second transition periods to be added to a front and back of the basic noise generation period to a front and back of the basic noise amplitude signal based on the voltage signal, respectively, to produce a noise amplitude signal.

Also, the processing unit may determine a start time of the basic noise generation period based on a threshold and the voltage signal with a minimum delay, and determining an end time of the basic noise generation period based on the threshold and the voltage signal with a maximum delay.

Also, the processing unit may add the first signal portion in the first transition period to the front of the basic noise amplitude signal based on a rising waveform of the voltage signal with a minimum delay, and add the second signal portion in the second transition period to the back of the basic noise amplitude signal based on a falling waveform of the voltage signal with a maximum delay. In this case, desirably, the first signal portion is a gradually increasing signal, and the second signal portion is a gradually decreasing signal.

Also, the processing unit may group the plurality of circuit nets into groups based on a clock signal to be used; and add the noise amplitude signals for each of the circuit nets operating based on the same clock signal to produce a composite noise amplitude signal for the victim net.

Also, the processing unit may add an extension period signal in an extension period after the basic noise generation period before the second transition period to the back of the basic noise amplitude signal, to produce the noise amplitude signal in which the first and second signal portions and the extension period signal are added. The extension period signal in the extension period may have a same amplitude as that of the basic noise amplitude signal.

Also, the processing unit may separate the basic noise amplitude signal into first and second basic noise amplitude signal based on a clock period when the basic noise generation period is over two clock periods; shift the second basic noise amplitude signal at a start of the clock period; and when the first and second transition periods overlap, take a larger one of the first and second signal portions for the overlapping period.

Also, the processing unit may separate the basic noise amplitude signal into first and second basic noise amplitude signal based on a clock period when the basic noise generation period is over two clock periods; shift the second basic noise amplitude signal at a start of the clock period; and when the extension period and a period for the first basic noise amplitude signal overlap, take the extension period signal for the overlapping period.

In still another aspect of the present invention, a computer-readable software product for realizing either of the above crosstalk calculating methods is provided.

### BRIEF DESCRIPTION OF THE DRAWINGS

FIG. 1 shows a configuration of a conventional semiconductor circuit;

FIGS. 2A to 2D are diagram showing specific examples of the turbulence of a signal waveform due to a crosstalk;

FIGS. 3A to 3C are diagrams showing a voltage signal and noise amplitude signals that are calculated by a conventional crosstalk calculating method based on the voltage signal transferred on an aggressor net;

FIG. 4 is a circuit diagram showing a specific example of a conventional semiconductor integrated circuit;

FIG. 5 shows a process of analyzing crosstalk to a net by the conventional crosstalk calculating method;

FIG. 6 is a block diagram showing a configuration of a crosstalk calculating apparatus to carry out a crosstalk calculating method of the present invention;

FIGS. 7A to 7C are diagrams showing the crosstalk calculating method of the present invention to determine a noise amplitude signal;

FIG. 8 is a diagram showing a noise amplitude signal in detail, which is calculated by the crosstalk calculating method of the present invention;

FIG. 9 is a block diagram showing a configuration of the semiconductor integrated circuit having a plurality of aggressor nets as an example;

FIGS. 10A to 10C are diagrams showing the calculated noise amplitudes signals from groups of a plurality of the aggressor nets, respectively;

FIGS. 11A to 11C are diagrams showing composite noise amplitude signals which are obtained by adding the calculated noise amplitude signals based on the timing windows for every control clock;

FIG. 12 is a conceptual diagram in the calculation of the amplitude of a final noise amplitude signal 94 applied to the victim net 20;

FIG. 13 is a conceptual diagram showing overlapping of the periods; and

FIG. 14 is a conceptual diagram showing a calculation of the amplitude of the noise amplitude signal, when the transition periods overlap;

FIG. 15 is a conceptual diagram of the calculation of the amplitude of the noise amplitude signal when the extension periods overlap.

### DESCRIPTION OF THE PREFERRED EMBODIMENTS

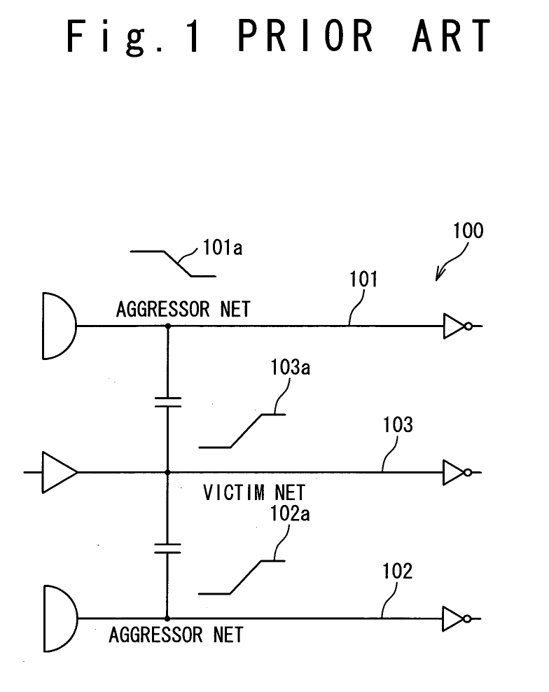

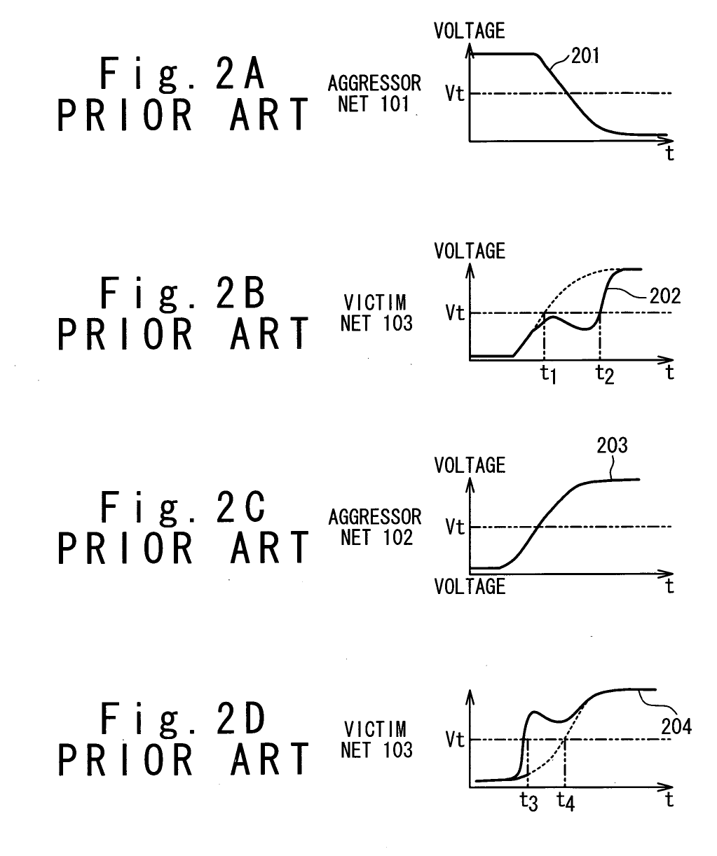

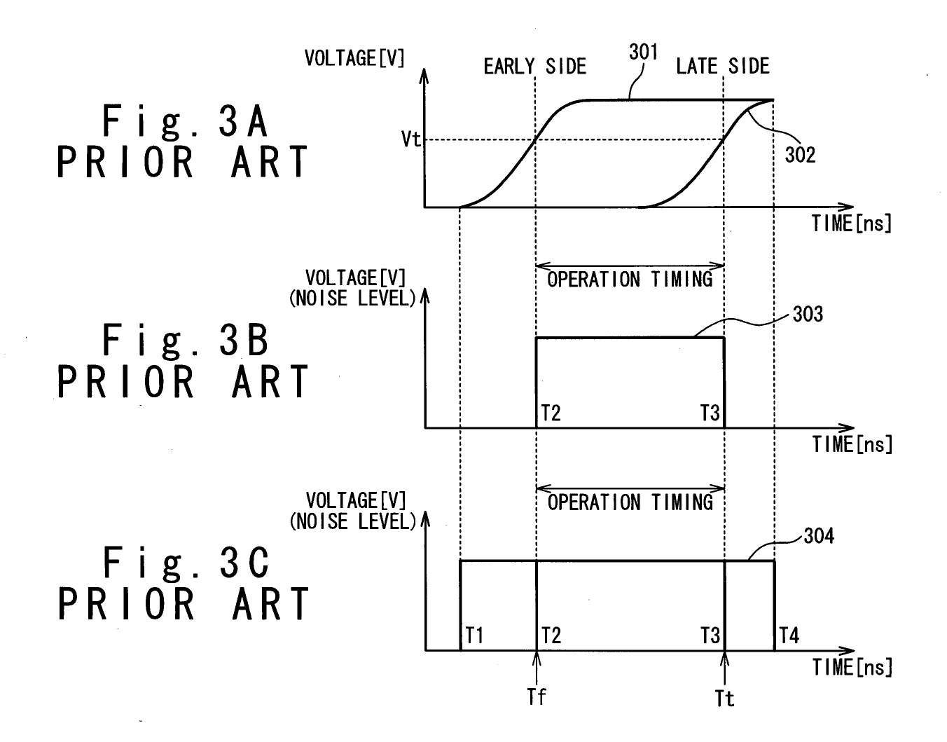

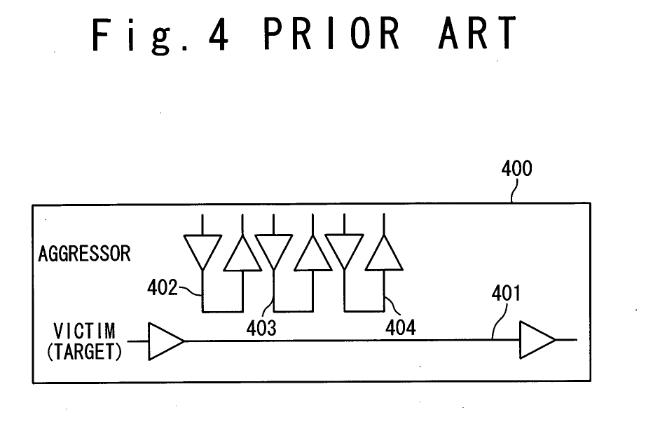

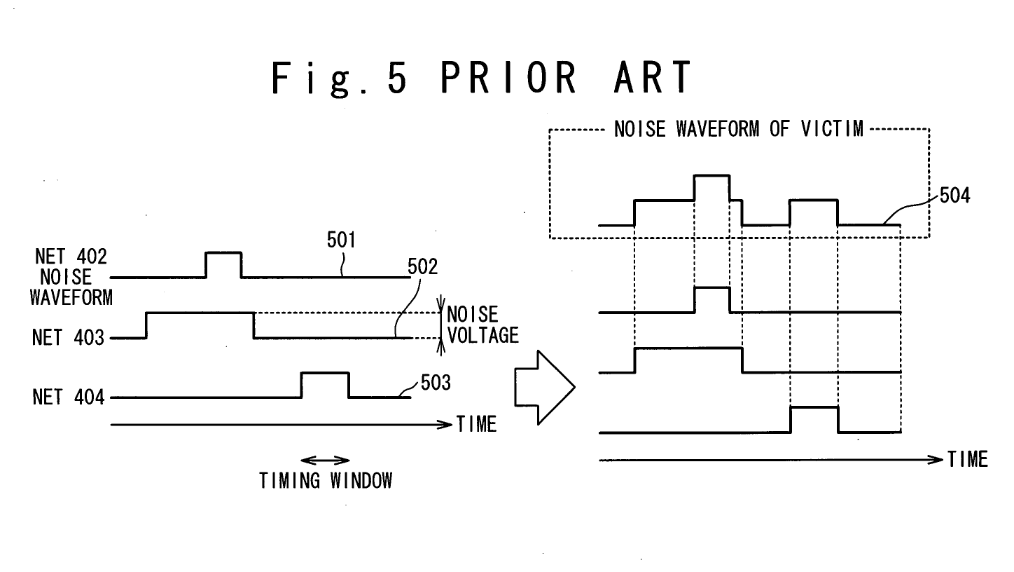

Hereinafter, a noise calculation method of the present invention will be described in detail with reference to the attached drawings. A crosstalk calculating method of the present inventions can be applied to a semiconductor integrated circuit of any circuit structure as an analysis object of the crosstalk. Therefore, in order to facilitate the understanding of the present invention, the circuit shown in FIG. 1 is used as an analysis object in the following description.

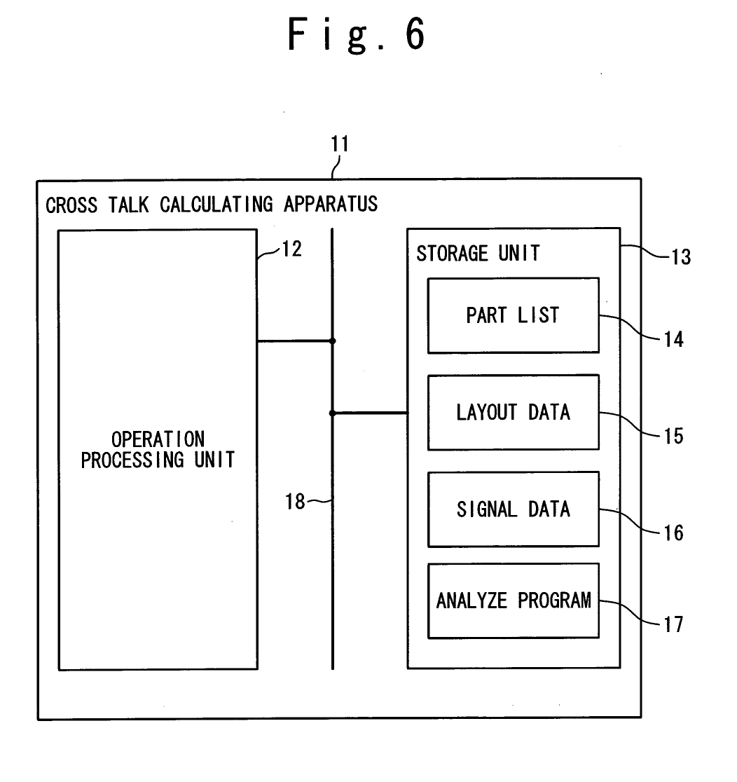

FIG. 6 is a block diagram showing a configuration of a crosstalk calculating apparatus to carry out the crosstalk calculating method of the present invention. A crosstalk analysis of a semiconductor integrated circuit has been accomplished by executing a crosstalk analyze program by a computer. There is no specific limitation in the configuration of the computer to accomplish the present invention. As shown in FIG. 6, a crosstalk calculating apparatus 11 includes a processor 12 and a storage unit 13, which are connected each other through a bus 18. Exchange of data between them is carried out through the bus 18. The processor 12 is a data processor with at least one processing unit. The processor 12 starts a program to carry out a predetermined process in response to the operation execution instruction received through the bus 18.

The storage unit 13 shown in FIG. 6 is a data storage unit such as a HDD (Hard Disk Drive such as a magnetic storage device) and a semiconductor storage unit. The storage unit 13 receives a data reading instruction through the bus 18, and outputs a corresponding data in response to the received instruction. Also, the storage unit 13 stores data in a predetermined region in response to a write instruction, as well as reads the data in response to a read data instruction. The storage unit 13 in the crosstalk calculating apparatus 11 according to the embodiment of the present invention includes a part list 14, a layout data 15, a signal data 16, and an analyze program 17.

The part list 14 stores data concerning various parts necessary to appropriately design the semiconductor integrated circuit as an electronic data, for instance, registers, inverters, and selectors and the like. When there are a plurality of parts having a same function, the part list 14 stores the data of these parts as electronic data.

The layout data 15 stores a data concerning a layout of the semiconductor integrated circuit to be designed. In the crosstalk analysis of the semiconductor integrated circuit, the crosstalk calculating apparatus 11 specifies the data for the layout of the semiconductor circuit, and is carried out based on the layout data 15. When the layout is to be changed as the result of the above-mentioned crosstalk analysis, the crosstalk calculating apparatus 11 stores the data concerning the changed layout in the storage unit 13 as a new layout data 15.

The signal data 16 stores a data concerning signals transferred in the semiconductor integrated circuit to be designed. In addition, the crosstalk calculating apparatus 11 specifies voltage signals to be transferred on the specified layout of the semiconductor circuit together based on the signal data 16. Then, the crosstalk calculating apparatus 11 calculates the crosstalk of the semiconductor integrated circuit to be designed.

The analyze program 17 is a computer program to analyze the crosstalk of the semiconductor integrated circuit to be designed. In the crosstalk calculating apparatus 11, the operation processing unit 12 reads and executes the analyze program 17 to analyze the crosstalk. The analyze program 17 of the present invention is not limited to a single program. That is, the analyze program 17 may include a plurality of programs and it is possible to analyze the crosstalk by executing a combination of the plurality of programs.

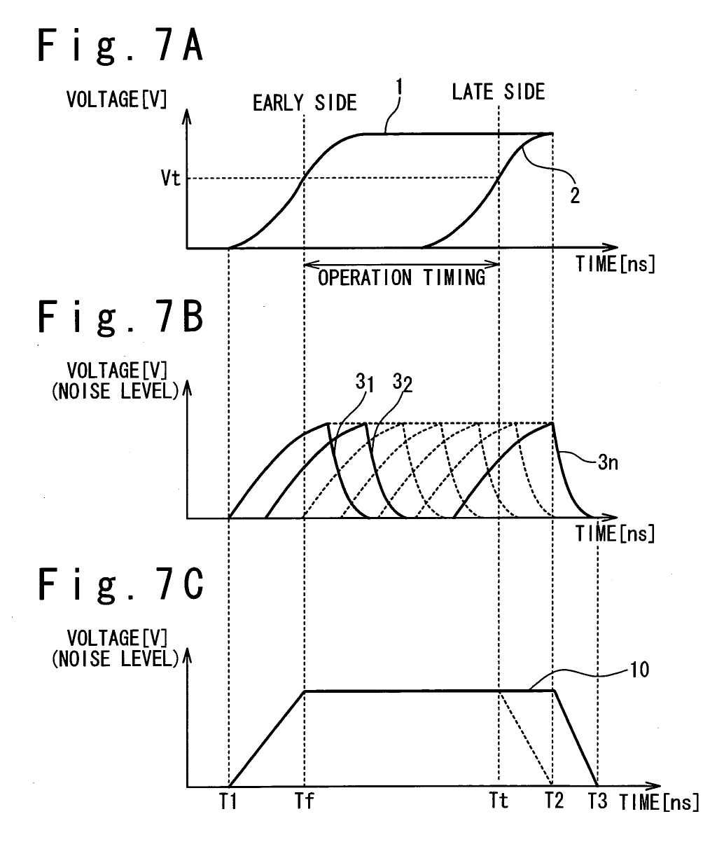

Next, the crosstalk calculating method of the present invention carried out by the crosstalk calculating apparatus 11 will be described below. FIGS. 7A to 7C shows the crosstalk calculating method of the present invention to determine a noise amplitude signal.

In the following description of the crosstalk calculating method, the crosstalk is calculated in consideration of an extension period (Tt-T2) shown in FIG. 7A to improve the accuracy of the calculated crosstalk. It may be also calculated without considering the extension period (Tt-T2) when it is needed to shorten the calculation time. Moreover, in the following description, the crosstalk is calculated based on noise waveforms (31-3n). However, this does not means that the present invention requires the noise waveforms (31-3n) to calculate a noise amplitude signal 10. The details concerning the noise amplitude signal 10 will be described later.

FIG. 7A shows a time-dependent change of the voltage signal on an aggressor net. The waveform of a first signal 1 shows a waveform when delay of the signal transferred on the aggressor net is minimum, and a second signal waveform 2 shows a waveform when the delay of the signal is maximum. Also, in the aggressor net, the time when the first signal 1 as the voltage signal reaches a threshold voltage Vt is defined as a time Tf. The time when the second signal 2 as the voltage signal reaches the threshold voltage is defined as a time Tt. An operation timing period of the aggressor net is from the time Tf to the time Tt.

FIG. 7B shows a time-dependent change of a noise voltage on the victim net. A plurality of noise waveforms (31-3n) shown in FIG. 7B are waveforms of a noise voltage signal generated in response to the time-dependent voltage change of the voltage signal on the above-mentioned aggressor net. As shown in FIG. 7B, when a voltage signal is transferred on the aggressor net in the above-mentioned operation timing period, any one of the noise waveforms 31 to 3n is generated in response to the voltage signal as the noise signal. For instance, when the voltage signal corresponding to the first signal 1 shown in FIG. 7A is transferred on the aggressor net, the noise voltage signal with the noise waveform 31 is generated on the victim net. The noise voltage signal with the noise waveform 32 is generated on the victim net when the voltage signal on the aggressor net is supplied to the victim net with a slight delay.

FIG. 7C is shows a noise amplitude signal 10 calculated by the crosstalk calculating method of the present invention. The noise amplitude signal 10 indicates a noise signal possibly generated when the voltage signal shown in FIG. 7A is transferred on the aggressor net.

Referring to FIGS. 7A to 7C, the time T1 is a time when the first signal 1 starts to change in voltage. The time Tf is time when the first signal 1 reaches the threshold voltage Vt. Also, the time Tt is a time when the second signal 2 in FIG. 7A reaches the threshold voltage Vt. The time T2 is a time when the second signal 2 reaches the High level (the power supply voltage). In addition, the time T3 is a time when a noise voltage signal with the waveform 3n generated corresponding to the second signal 2 reaches the Low level (the earth voltage). As shows by the noise amplitude signal 10 in FIG. 7C, the crosstalk noise calculated by the calculating method of the present invention has a portion increasing in proportion to the time in the period from the time T1 to the time Tf, and a portion decreasing in proportion to time in the period from the time T2 to the time T3, unlike the conventionally calculated crosstalk noise.

As mentioned above, the noise waveform at an arbitrary timing in the period from time Tf to the time Tt is any one of the plurality of the noise waveforms (31-3n) shown in FIG. 7B. It is impossible to analyze the crosstalk based on noise generated at an arbitrary timing when the semiconductor integrated circuit is designed. Therefore, the noise amplitude signal 10 shown in FIG. 7C is calculated and the crosstalk analysis is carried out based on the calculated noise amplitude signal 10. Then, an appropriate crosstalk analysis can be carried out.

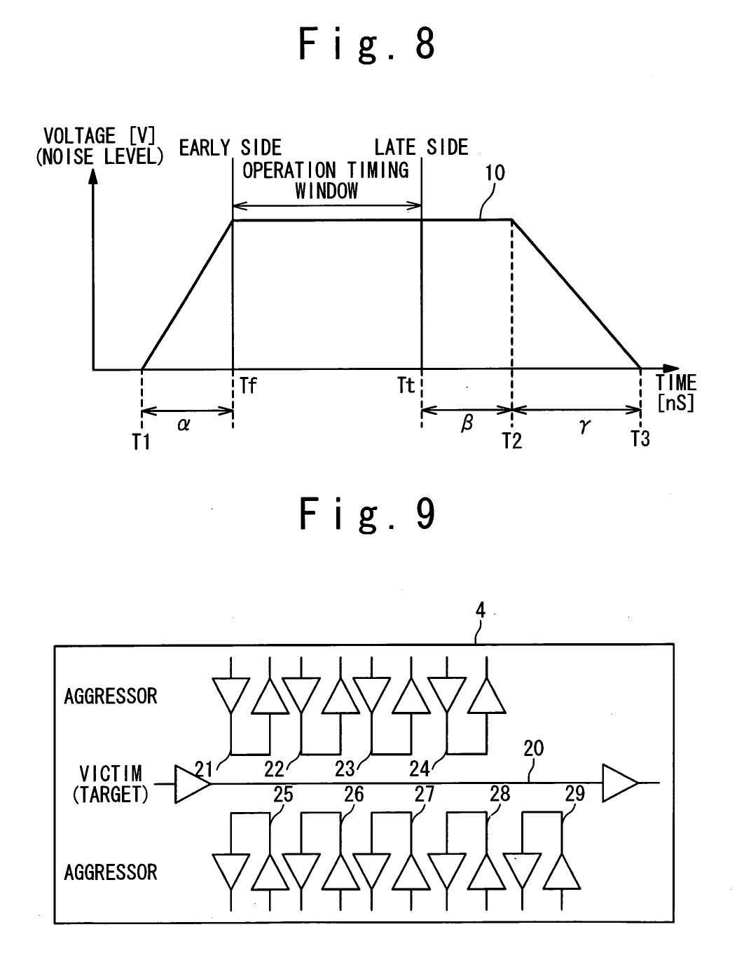

FIG. 8 shows the noise amplitude signal 10 in detail, which is calculated by the crosstalk calculating method of the present invention. Referring to the noise amplitude signal 10 shown in FIG. 8, the crosstalk calculating method of the present invention will be described below. Here, x-axis in FIG. 8 indicates the time when the crosstalk is generated, and y-axis indicates the amplitude of the noise (the voltage). Also, in the following description, it is supposed that a voltage signal actually transferred on the aggressor net has the waveform as shown in FIG. 7A, as an example. The amplitude of the noise signal corresponding to the voltage signal is calculated by the crosstalk calculating method of the present invention. Hereinafter, a period of the noise signal from the time Tf to the time Tt is referred to as an operation timing window as a basic period.

It is assumed that the amplitude of the voltage signal on the aggressor net at a certain time t is Vnt, the period from the time T1 to the time Tf is a period α, the period from the time Tt to the time T2 is a period β, and the period from the time T 2 to the time T3 is a period γ. In this case, the amplitude Vn of the noise amplitude signal satisfies following equations. That is;
In case of t≦(Tf−α), Vnt=0 (1)
In case of (Tf−α)<t<Tf Vnt={t−(Tf−α)}/α*Vn (2)
In case of Tf≦t≦(Tt+β), Vnt=Vn (3)
In case of (Tt+β)<t<(Tt+β+γ), Vnt=[γ−{t−(Tt+β)}]/γ*Vn (4)
In case of (Tt+β+γ)≦t, Vnt=0 (5)
where α, β, and γcan be expressed as follows. That is,
α=TRa*Vt/Vdd,
β=TRa*(l-Vt/Vdd), and
γ=TRv*(Vn/Vdd)
   where Vn [V] is the maximum amplitude of the voltage signal on the aggressor net, TRa [nS] is the output waveform slew time from the aggressor net (TRaRise in the rising noise, TRaFall at the falling noise), TRv [nS] is the input waveform slew time to the victim net (TRvFall in the rising noise, TRvRise in the falling noise), the period of the operation timing window is between the time Tf to the time Tt [nS], and Vt [V] is the threshold voltage of a logical threshold.

Calculating the timing window that satisfies the above-mentioned expressions (1) to (5), the noise amplitude signal 10 with the waveform shown in FIG. 8 can be obtained. Referring to FIG. 8, it is shown that the amplitude of the noise amplitude signal changes in the periods α and γ as time passes, according to the crosstalk calculating method of the present invention. A noise generation period has been extended to include the period β. Even if a shift of the voltage signal on the aggressor net is caused, so that a new crosstalk is generated, the calculated noise amplitude signal 10 can absorb the shift of the operation timing, by calculating the above-mentioned timing window. Thus, it is possible to reduce a rapid generation and disappearance of the noise signal. Also, it is possible to carry out the analysis in appropriate consideration of the amplitude of the noise when the voltage signal on the aggressor net is equal to or less than the logic threshold Vt

Generally, when one victim net is specified in the semiconductor integrated circuit, there are a plurality of aggressor nets that influences the victim net. Also, some of the semiconductor integrated circuits operate in response to a plurality of control clocks. In the following description, the crosstalk analysis when the crosstalk calculating method of the present invention is applied to such a circuit will be described. FIG. 9 is a block diagram showing a configuration of the semiconductor integrated circuit having a plurality of aggressor nets as an example. A circuit 4 shown in FIG. 9 operates based on a plurality of control clocks (CLK1, CLK2, CLK3). As shown in FIG. 9, the circuit 4 is configured of a plurality of aggressor nets (21-29) and a victim net 20. Here, the aggressor nets (21-23) operate based on the first control clock CLK 1. The aggressor nets (24-26) are circuits operate based on the second control clock CLK 2. The aggressor nets (27-29) operate based on the third control clock CLK 3. Also, the victim net 20 operates based on the first control clock CLK 1.

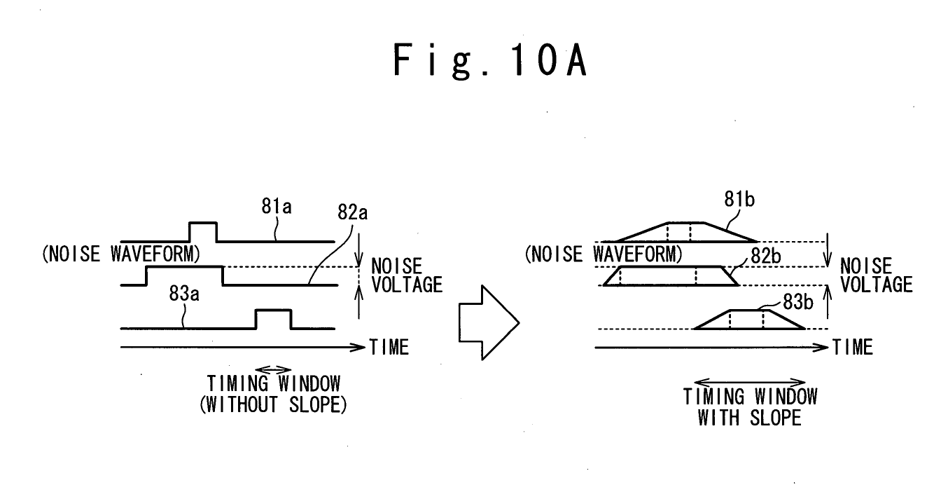

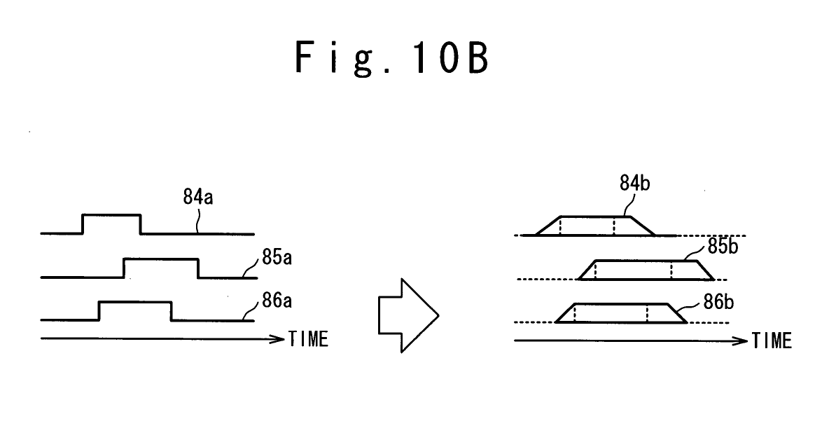

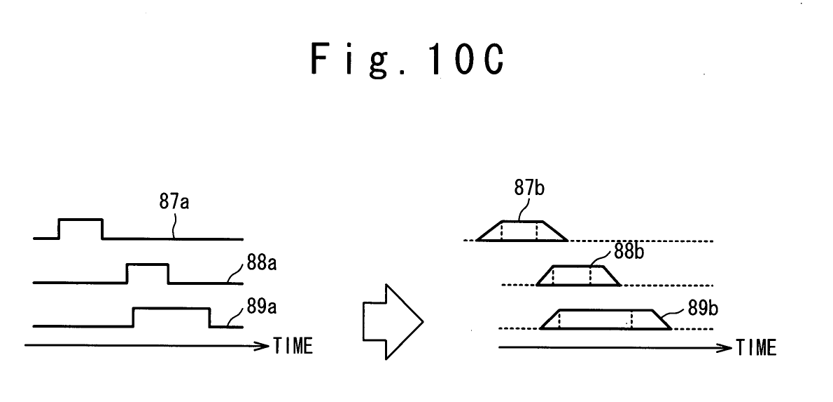

When the crosstalk calculating method of the present invention is applied to the circuit 4 operating based on the plurality of control clocks, a plurality of aggressor nets (21-29) are grouped into groups, in each of which the nets operate based on the same control clock. Since the first to third control clocks as operation clocks are present for the circuit 4, the circuit 4 is grouped into the aggressor nets (21-23) as a first control clock group; the aggressor nets (24-26) as a second control clock group; and the aggressor nets (27-29) as a third control clock group. A noise signal on the victim net 20 is analyzed for every group. FIG. 10A, FIG. 10B and FIG. 10C show the calculated noise amplitudes signals from the groups of the plurality of the aggressor nets (21-29), respectively.

FIG. 10A shows the amplitude of a crosstalk noise amplitude signal in the first control clock group. A signal 81a in FIG. 10A shows a basic noise signal calculated from the voltage signal transferred on the aggressor net 21, and indicates that the signal 81a has an amplitude from the time Tf to the time Tt. Similarly, A signal 82a shows a basic noise signal calculated from the voltage signal transferred on the aggressor net 22, and indicates that the signal 82a has an amplitude from the time Tf to the time Tt. A signal 83a shows a basic noise signal calculated from the voltage signal transferred on the aggressor net 23, and indicates that the signal 83a has an amplitude from the time Tf to the time Tt. A signal 81b shows a noise amplitude signal from the aggressor net 21 calculated from the signal 81a based on the timing window to satisfy the above-mentioned equations (1) to (5). Similarly, the waveform 82b shows a noise amplitude signal from the aggressor net 22, and the waveform 83b indicates a noise amplitude signal from the aggressor net 23.

FIG. 10B shows a crosstalk noise amplitude signal of the second control clock group. A signal 84a, a signal 85a, and a signal 86a shown in FIG. 10B correspond to the aggressor net 24, the aggressor net 25, and the aggressor net 26, respectively. Also, the signals 84a, 85a and 86a have the amplitudes from the time Tf to the time Tt. Also, a signal 84b, a signal 85b, and a signal 86b correspond to the aggressor net 24, the aggressor net 25, and the aggressor net 26, respectively, and indicate noise amplitude signals calculated from the signals 84a, 85a, and 86a based on the timing window to satisfy the above-mentioned equations (1) to (5).

Similarly, FIG. 10C shows the crosstalk noise amplitude signals of the third control clock group. A signal 87a, a signal 88a, and a signal 89a shown in FIG. 10C correspond to the aggressor net 27, the aggressor net 28, and the aggressor net 29, respectively, and have the amplitudes from the time Tf to the time Tt. Also, a signal 87b, a signal 88b, and a signal 89b correspond to the aggressor net 27, the aggressor net 28, and the aggressor net 29, respectively, and indicate the noise amplitude signals calculated from the signals 87a, 88a and 89a based on the timing windows to satisfy the above-mentioned equations (1) to (5).

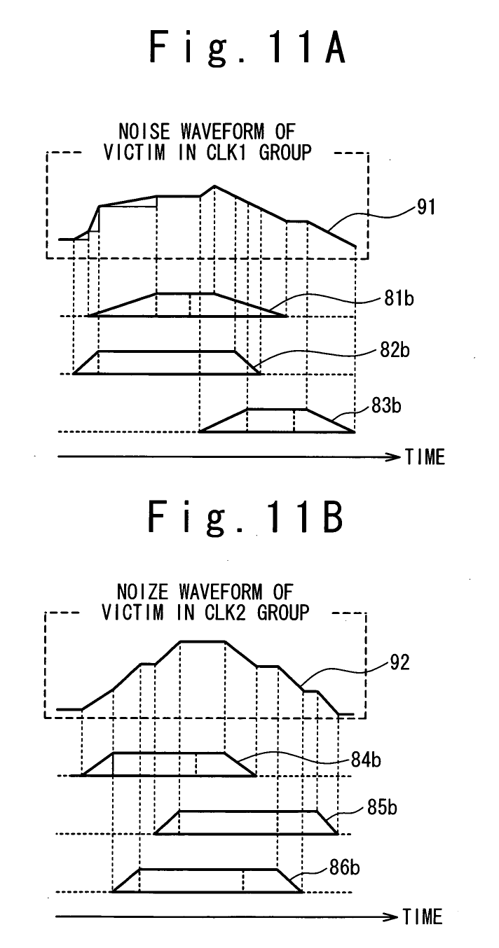

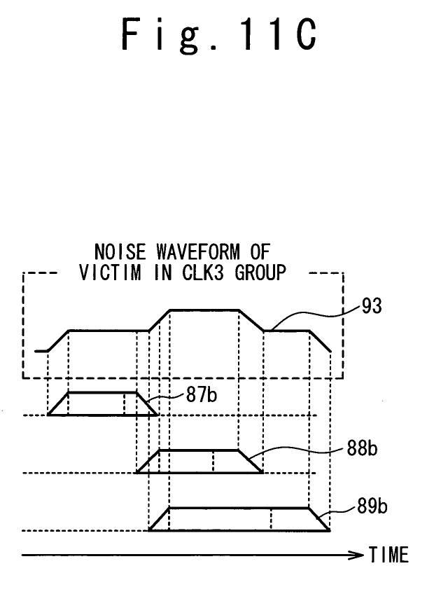

The calculated noise amplitude signals are combined based on the timing windows (81b, 82b, . . . , 89b) for the aggressor nets (21-29) for every control clock. FIGS. 11A, 11B and 11C show composite noise amplitude signals which are obtained by adding the calculated noise amplitude signals based on the timing windows for every control clock and the composite noise amplitude signals influence the victim net 20.

FIG. 11A indicates the composite noise amplitude signal acting on the victim net 20 in response to the voltage signals transferred on the aggressor nets in synchronism with the first control clock CLK 1. A first composite noise amplitude signal 91 shown in FIG. 11A has a time-dependent amplitude calculated by the crosstalk calculating method of the present invention. As shown in the first composite noise amplitude signal 91, the amplitude of the composite noise amplitude signal on the victim net 20 is calculated by adding the amplitudes of the noise amplitude signals 81b, 82b and 83b from the aggressor nets (21-23) included in the first control clock group. The addition of the amplitudes of the noise amplitude signals 81b, 82b and 83b are carried out based on the times (T1-T3, Tf, and Tt) corresponding to the timing windows (81b, 82b, and 83b) for the voltage signals on the aggressor nets (21-23). As a result, the calculation of the amplitudes of the noise amplitude signals 81b, 82b and 83b becomes effective. Similarly, a second composite noise amplitude signal 92 shown in FIG. 11B is calculated through addition of the amplitudes of the noise amplitude signals 84b, 85b and 86b influenced from the voltage signals transferred on the aggressor nets (24-26) in synchronism with the second control clock CLK 2. Further, a third composite noise amplitude signal 93 shown in FIG. 11C is calculated through the addition of the amplitudes of the noise amplitude signals 87b, 88b and 89b influenced from the voltage signals transferred on the aggressor nets (27-29) in synchronism with the third control clock CLK 3.

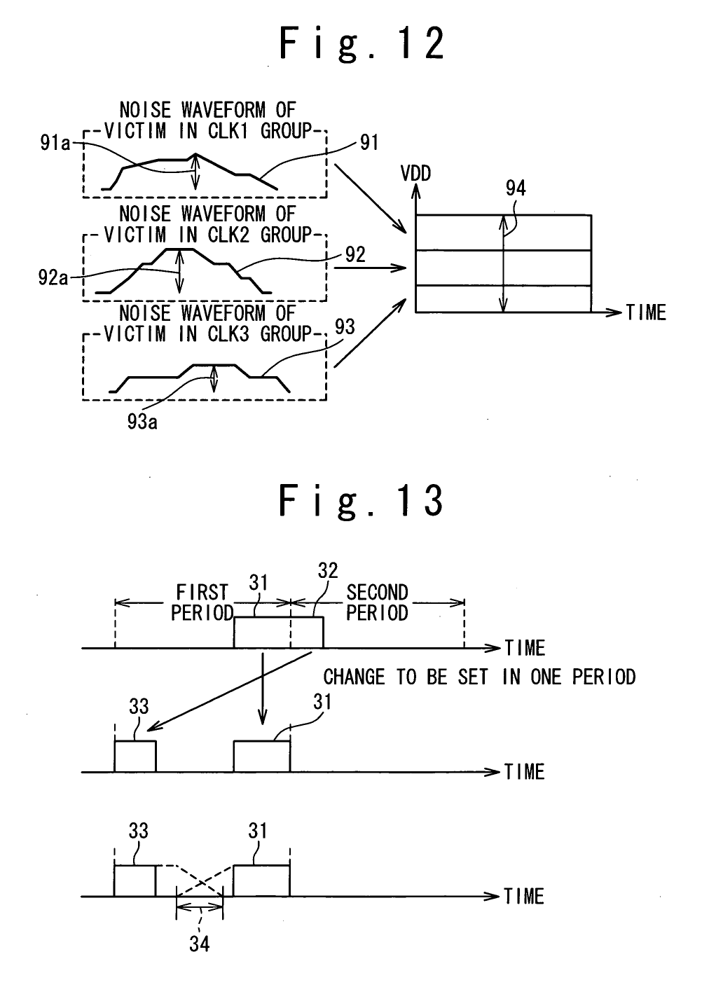

After the calculation of the amplitudes of the composite noise amplitude signals 91 to 93 for every control clock (CLK 1, CLK 2, CLK 3) is completed, a calculation of the amplitude of the noise which the victim net 20 receives, and a delay is carried out based on the first to third composite noise amplitudes signals 91 to 93. FIG. 12 is a conceptual diagram in the calculation of the amplitude of a final noise amplitude signal 94 acting on the victim net 20. As shown in FIG. 12, in the crosstalk calculating method of the present invention, a sum of the maximum values of the amplitudes of the composite noise amplitude signals 91 to 93 calculated for every control clock (CLK 1, CLK 2, CLK 3) is used as the final noise amplitude signal 94 acting on the victim net 20.

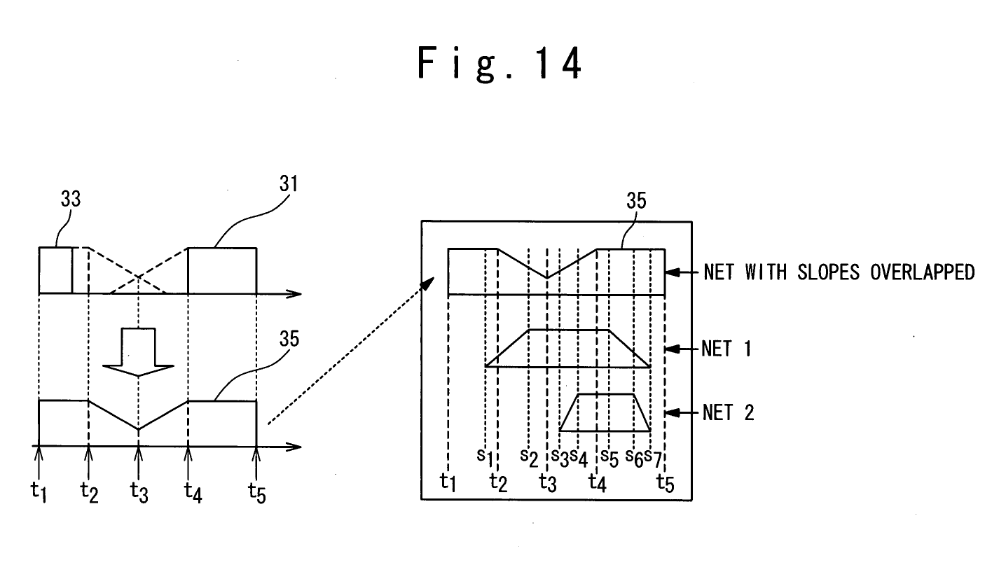

In the crosstalk calculating method of the present invention, addition of transition periods and period extension are carried out to the timing window from each of the plurality of aggressor nets. In this way, due to the generation of transition periods and period extension to the operation timing window, the transition period and the extension period sometimes overlap at the time Tf (a early side) and the time Tt (a late side) in the operation timing window in light of one period. FIG. 13 is a conceptual diagram showing such overlapping of the periods. Referring to FIG. 13, a timing window over two periods is divided into a signal 31 and a signal 32. Then, the signal 32 is shifted as a signal 33 so as to be accommodated in one period, and the transition periods and the extension period are calculated in each of the signals. Here, FIG. 13 shows overlapping of the transition periods in the period 34. FIG. 14 is a conceptual diagram showing a calculation of the amplitude of the noise amplitude signal, when the transition periods overlap. As shown by the signal 35 in FIG. 14, when the transition periods overlap in one period, the amplitude of the noise amplitude signal is calculated based on a larger one of the amplitudes of the noise amplitude signals. In addition, when a composite noise amplitude signal for each control clock group is calculated, the amplitudes of the noise amplitude signals are added based on the period from the time t1 to time t5 corresponding the waveform 35 and the period from the time s1 to s7 corresponding to waveforms from other aggressor nets. As a result, it is possible to appropriately calculate the amplitude of the noise amplitude signal even if the transition periods overlap. Therefore, it is possible to design a proper semiconductor integrated circuit in a short time.

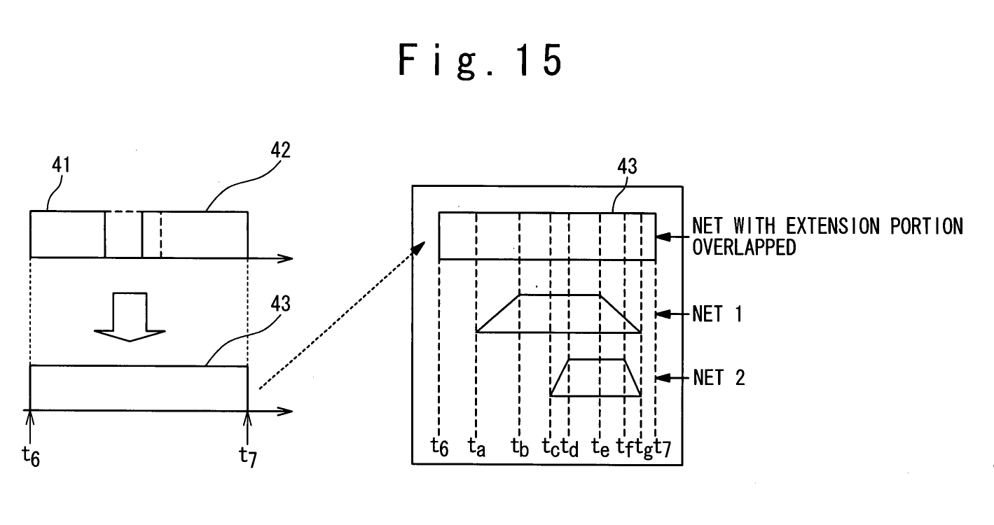

FIG. 15 is a conceptual diagram of the calculation of the amplitude of the noise amplitude signal when the extension periods overlap. The signals 41 and 42 shown in FIG. 15 are obtained by dividing the timing window over two periods, like the signals 31 and 32 shown in FIG. 13. Referring to FIG. 15, the extension period from the time Tt to the time T2 for the signal 41 overlaps with the signal 42. Thus, the signal 43 is formed. When the periods overlaps due to the extension period from the time Tt (the late side) to the time T2 within one period, the operation timing window is set in such a manner that the noise is always generated. As a result, even if the extension periods overlap, it is possible to properly calculate the amplitude of the noise amplitude signal. Therefore, it is possible to design a proper circuit in a short term, as well as a case that the transition periods overlap in the design of the semiconductor integrated circuit.

1. A crosstalk calculating method comprising:
determining a basic noise amplitude signal applied to a victim net in a basic noise generation period specified based on a voltage signal transferred on an aggressor net in a semiconductor circuit; and
adding first and second signal portions applied to said victim net in first and second transition periods to be added to a front and back of said basic noise generation period to a front and back of said basic noise amplitude signal based on said voltage signal, respectively, to produce a noise amplitude signal.

2. The crosstalk calculating method according to claim 1, wherein said determining a noise amplitude signal comprises:
determining a start time of said basic noise generation period based on a threshold and said voltage signal with a minimum delay; and
determining an end time of said basic noise generation period based on said threshold and said voltage signal with a maximum delay.

3. The crosstalk calculating method according to claim 1, wherein said adding first and second signal portions comprises:
adding said first signal portion in said first transition period to the front of said basic noise amplitude signal based on a rising waveform of said voltage signal with a minimum delay; and
adding said second signal portion in said second transition period to the back of said basic noise amplitude signal based on a falling waveform of said voltage signal with a maximum delay.

4. The crosstalk calculating method according to claim 3, wherein said first signal portion is a gradually increasing signal, and said second signal portion is a gradually decreasing signal.

5. The crosstalk calculating method according to claim 1, further comprising:
carrying out said determining a basic noise amplitude signal and said adding first and second signal portions for each of a plurality of said aggressor nets in said semiconductor circuit;
grouping said plurality of aggressor nets into groups based on a clock signal to be used; and
adding said noise amplitude signals for each group to produce a composite noise amplitude signal for said victim net.

6. The crosstalk calculating method according to claim 1, further comprising:
separating said basic noise amplitude signal into first and second basic noise amplitude signal based on a clock period when said basic noise generation period is over two clock periods; and
shifting said second basic noise amplitude signal at a start of said clock period,
wherein said adding first and second signal portions comprises:
taking, when said first and second transition periods overlap, a larger one of said first and second signal portions for said overlapping period.

7. A crosstalk calculating apparatus comprising:
a part database configured to store data of parts of a semiconductor circuit which comprises a plurality of circuit nets;
a layout database configured to store data of a layout of said semiconductor circuit;
a signal database configured to store signals on said plurality of circuit nets; and.
a processing unit configured to carry out a crosstalk calculating process,
wherein said processing unit:
specifies one of said plurality of circuit nets as a victim net and another of said plurality of circuit nets as an aggressor net;
refers to said part database, said layout database and said signal database to determine a basic noise amplitude signal applied to a victim net in a basic noise generation period specified based on a voltage signal transferred on an aggressor net in a semiconductor circuit; and
adds first and second signal portions applied to said victim net in first and second transition periods to be added to a front and back of said basic noise generation period to a front and back of said basic noise amplitude signal based on said voltage signal, respectively, to produce a noise amplitude signal.

8. The crosstalk calculating apparatus according to claim 7, wherein said processing unit determines a start time of said basic noise generation period based on a threshold and said voltage signal with a minimum delay, and determining an end time of said basic noise generation period based on said threshold and said voltage signal with a maximum delay.

9. The crosstalk calculating apparatus according to claim 7, wherein said processing unit adds said first signal portion in said first transition period to the front of said basic noise amplitude signal based on a rising waveform of said voltage signal with a minimum delay, and adds said second signal portion in said second transition period to the back of said basic noise amplitude signal based on a falling waveform of said voltage signal with a maximum delay.

10. The crosstalk calculating apparatus according to claim 9, wherein said first signal portion is a gradually increasing signal, and said second signal portion is a gradually decreasing signal.

11. The crosstalk calculating apparatus according to claim 7, wherein said processing unit:
groups said plurality of circuit nets into groups based on a clock signal to be used; and
adds said noise amplitude signals for each of said circuit nets operating based on the same clock signal to produce a composite noise amplitude signal for said victim net.

12. The crosstalk calculating apparatus according to claim 7, wherein said processing unit:
separates said basic noise amplitude signal into first and second basic noise amplitude signal based on a clock period when said basic noise generation period is over two clock periods;
shifts said second basic noise amplitude signal at a start of said clock period; and
when said first and second transition periods overlap, takes a larger one of said first and second signal portions for said overlapping period.

13. A computer-readable software product for realizing a crosstalk calculating method, wherein said crosstalk calculating method comprises:
determining a basic noise amplitude signal applied to a victim net in a basic noise generation period specified based on a voltage signal transferred on an aggressor net in a semiconductor circuit; and
adding first and second signal portions applied to said victim net in first and second transition periods to be added to a front and back of said basic noise generation period to a front and back of said basic noise amplitude signal based on said voltage signal, respectively, to produce a noise amplitude signal.

14. The computer-readable software product according to claim 13, wherein said determining a noise amplitude signal comprises:
determining a start time of said basic noise generation period based on a threshold and said voltage signal with a minimum delay; and
determining an end time of said basic noise generation period based on said threshold and said voltage signal with a maximum delay.

15. The computer-readable software product according to claim 13, wherein said adding first and second signal portions comprises:
adding said first signal portion in said first transition period to the front of said basic noise amplitude signal based on a rising waveform of said voltage signal with a minimum delay; and
adding said second signal portion in said second transition period to the back of said basic noise amplitude signal based on a falling waveform of said voltage signal with a maximum delay.

16. The computer-readable software product according to claim 15, wherein said first signal portion is a gradually increasing signal, and said second signal portion is a gradually decreasing signal.

17. The computer-readable software product according to claim 13, wherein said crosstalk calculating method further comprises:
carrying out said determining a basic noise amplitude signal and said adding first and second signal portions for each of a plurality of said aggressor nets in said semiconductor circuit;
grouping said plurality of aggressor nets into groups based on a clock signal to be used;
adding said noise amplitude signals for each group to produce a composite noise amplitude signal for said victim net.

18. The computer-readable software product according to claim 13, wherein said crosstalk calculating method further comprises:
separating said basic noise amplitude signal into first and second basic noise amplitude signal based on a clock period when said basic noise generation period is over two clock periods; and
shifting said second basic noise amplitude signal at a start of said clock period,
wherein said adding first and second signal portions comprises:
taking, when said first and second transition periods overlap, a larger one of said first and second signal portions for said overlapping period.
